(19) United States
(12) Patent Application Publication
(10) Pub. No.: US 2026/0186851 A1
(43) Pub. Date: Jul. 2, 2026

(54) MACHINE LEARNING (ML) - ASSISTED PRESENTATION HOSTING PLATFORM

(71) Applicants: Constructor Technology AG, Schaffhausen (CH); Constructor Education and Research Genossenschaft, Schaffhausen (CH)

(72) Inventors: Andrei ADASCHIK, Istanbul (TR); Svetlana DERGACHEVA, Sofia (BG); Nikita ZHEREBTSOV, Sofia (BG); Serg BELL, Singapore (SG); Stanislav PROTASOV, Singapore (SG); Nikolay DOBROVOLSKIY, Alanya (TR); Laurent DEDENIS, Geneve (CH)

(21) Appl. No.: 19/006,601

(22) Filed: Dec. 31, 2024

(51) Int. Cl. G06F 9/50; G06F 11/3668

(52) U.S. Cl. CPC G06F 9/5055; G06F 9/505; G06F 11/3668

(57) ABSTRACT

Disclosed herein are systems and methods for providing a machine learning (ML)- assisted presentation hosting platform. An example method includes receiving presentation materials associated with a presentation, analyzing the presentation materials by a first ML model to predict a presentation scenario, collecting information about a plurality of devices and/or software available to a plurality of participants of the presentation, analyzing the presentation scenario and the collected information by a second ML model to predict a mapping of one or more activities to the one or more devices and/or software of the participants, based on the configuration, resources, capabilities and/or load of the devices and/or software, and executing the presentation, including causing the one or more devices and/or software of the participants to perform the mapped activities based on the mapping.

### FIELD

The present disclosure relates to the field of machine learning, and, more specifically, to systems and methods for using machine learning to provide a presentation hosting platform.

### BACKGROUND

Presentation and meeting hosting platforms, such as Zoom and Teams, typically allow multiple users to participate in virtual video/audio meetings, share their screens, and display presentations and other content on their devices such as smartphone, laptop computer, desktop computer, etc. However, existing presentation hosting platforms have limited functionality in that they lack technical capability to effectively support various types of presentation content and additional interactive activities that may be associated with the presentation. Existing presentation hosting platforms cannot intelligently adapt to participant activities required in different types of presentation scenarios (such as a small group meeting, a large academic lecture, or a conference) and different presentation formats (such as online, offline, or hybrid). Further, existing presentation hosting platforms do not efficiently utilize various types of peripheral computer devices that may be available to participants of the presentation, such as various webcams, speakers, VR headsets, etc.

### SUMMARY

Aspects of the present disclosure describe a machine learning (ML)-assisted presentation hosting platform which addresses the shortcomings of conventional presentation hosting platforms described above. In one example aspect of the present disclosure, a presentation hosting platform uses ML technology to automatically create interactive, engaging, and technologically sophisticated custom presentation environments for different types/formats of meetings and presentations with minimal user guidance or instructions, thus improving user experience both for the presenter and for the participants. The presentation hosting platform uses available participant devices to increase participant interactivity and engagement under vastly different presentation scenarios and formats, thus providing significant technological improvement and versatility over existing technologies. For example, the presentation hosting platform is capable of opportunistically using available participant devices to support presentation scenarios such as online, offline, and hybrid meetings, small group meetings, large academic lectures, conferences, power point presentations, text/audio/video support, various interactive activities (e.g., group discussions, interactive questionnaires, multiple small-group virtual breakout sessions, smartboard and VR integration, etc.), etc.

In one aspect, the presentation hosting platform utilizes a trained ML model to analyze presentation material and identify various software and hardware components that are necessary for successful execution of various presentation scenarios and formats, including, for example, software components (e.g., applications, browser plugins, software libraries, device drivers, etc.), user devices (e.g., smartphone, laptop computer, desktop computer, etc.), peripheral devices (e.g., monitors, smartboards, projectors, webcams, speakers, surround sound systems, VR headsets, etc.), and network connections (e.g., Wi-Fi, cellular, Ethernet, etc.). The advanced ML functionality and automated features of the present aspects significantly simplify complicated organizational and technical tasks which are typically performed manually by IT administrators supporting the presentation, or by presenters or participants themselves, who may lack any technical expertise in computer and network technologies.

In one aspect, the presentation hosting platform utilizes a trained ML model to intelligently map various available participant devices, peripheral devices, and necessary software components, to activities associated with various presentation scenarios/formats. This ML functionality provides for customization and optimization of participant devices and computing resources specifically to a particular presentation scenario/format, improves communication between devices, and improves management of devices.

In one aspect, the presentation hosting platform is operable to automatically pre-configure, test, and intelligently manage various participant devices before and during a presentation, adaptively respond to any device failure, and optimize in real-time the use of network and computing resources of participants both in online and offline presentation formats. This functionality assures smooth presentation experience including presentation of audio/video/text materials, improved real-time audio/video playback, etc.

In one aspect, the presentation hosting platform may be used in an academic lecture scenario to assist teachers to create interactive, engaging, and technologically sophisticated educational experience for participants/learners. For example, the presentation hosting platform may use ML technology to analyze the text of a lecture and the description of activities for a current lesson from a teaching book and generate presentation scenarios that optimize use of available participant devices and network and computing resources. Specifically, for example, after analyzing the lecture and corresponding activities, the presentation hosting platform allows participants/learners to sign in with multiple devices simultaneously. The presentation hosting platform then analyzes accessible devices of a teacher/presenter and other participants/learners and their resources. The presentation hosting platform may optionally analyze data about the presentation venue (environment). The presentation hosting platform then recommends optimal configurations and additional activities that can be performed with the given devices and the lecture, and may update the recommendations in response to any changes in the scenario.

Accordingly, the presentation hosting platform uses ML models to help automate the selection of the presentation scenario, the device connections, and the optimization of the usage of the devices. This allows the presenter to focus on the content of the presentation without worrying about the technical aspects of setting up the equipment.

In one exemplary aspect, method of ML-assisted presentation hosting comprises: receiving, by a hosting platform, presentation materials associated with a presentation; analyzing the presentation materials by a first ML model to predict a presentation scenario, which indicates a format of the presentation, a plurality of activities associated with the presentation, and one or more devices and/or software that perform the activities; collecting information about a plurality of devices and/or software available to a plurality of participants of the presentation, wherein the collected information includes configuration, resources, capabilities, and/or load of the plurality of devices and/or software; analyzing the presentation scenario and the collected information by a second ML model to predict a mapping of the plurality of activities to the plurality of devices and/or software of the plurality of participants, based on the configuration, resources, capabilities, and/or load of the plurality of devices and/or software, wherein the mapping indicates, at least, which devices and/or software of the plurality of participants are capable to perform which activities of the presentation; and executing the presentation, by the hosting platform, including causing the plurality of devices and/or software of the participants to perform the mapped activities based on the mapping.

In one aspect, the plurality of participants include a presenter of the presentation, the method further comprising, prior to executing the presentation: providing the mapping on a user interface (UI) of a device associated with the presenter; and modifying the mapping based on user input received via the UI from the presenter.

In one aspect, the method further comprises: responsive to failure of at least one device and/or software in performing a mapped activity during the execution of the presentation, choosing, from the mapping, a different device and/or software to perform the failed activity of the presentation.

In one aspect, the method further comprises, prior to executing the presentation: generating a presentation configuration hypothesis based on the mapping of the plurality of activities to the plurality of devices and/or software; and testing the presentation configuration hypothesis by causing the plurality of devices and/or software to perform mapped ones of the plurality of activities, based on the mapping.

In one aspect, the method further comprises: responsive to failure of at least one device and/or software to perform a mapped activity during the testing of the presentation configuration hypothesis, using the second ML model to create an alternative mapping of the plurality of activities to the plurality of devices and/or software of the plurality of participants.

In one aspect, the configuration, resources, capabilities, and/or load of the plurality of devices and/or software comprises: one or more input/output capture devices available in the plurality of devices and/or software; a central processing unit (CPU) and/or memory load of the plurality of devices and/or software; a relative physical location of the plurality of devices and/or software within the scenario and/or with respect to each other and/or with respect to a participant of the presentation; a network speed/bandwidth of a communication medium used by the plurality of devices and/or software to communicate during the presentation; availability and compatibility of required software on the plurality of devices and/or software; and/or cybersecurity features of the plurality of devices and/or software.

In one aspect, the first ML model comprises a large language model (LLM), and the second ML model comprises one of a regression model, an encoder-decoder, and/or an autoencoder.

In another aspect, a system for ML-assisted presentation hosting comprises: at least one memory; and at least one hardware processor coupled with the at least one memory and configured, individually or in combination, to: receive presentation materials associated with a presentation; analyze the presentation materials by a first ML model to predict a presentation scenario, which indicates a format of the presentation, a plurality of activities associated with the presentation, and one or more devices and/or software that perform the activities; collect information about a plurality of devices and/or software available to a plurality of participants of the presentation, wherein the collected information includes configuration, resources, capabilities, and/or load of the plurality of devices and/or software; analyze the presentation scenario and the collected information by a second ML model to predict a mapping of the plurality of activities to the plurality of devices and/or software of the participants, based on the configuration, resources, capabilities, and/or load of the plurality of devices and/or software, wherein the mapping indicates, at least, which devices and/or software of the participants is capable to perform which activities of the presentation; and execute the presentation including causing the plurality of devices and/or software of the participants to perform the mapped activities based on the mapping.

In yet another aspect, a non-transitory computer readable medium storing thereon computer executable instructions for using machine learning (ML) to provide a presentation hosting platform, including instructions for: receiving, by a hosting platform, presentation materials associated with a presentation; analyzing the presentation materials by a first ML model to predict a presentation scenario, which indicates a format of the presentation, a plurality of activities associated with the presentation, and one or more devices and/or software that perform the activities; collecting information about a plurality of devices and/or software available to a plurality of participants of the presentation, wherein the collected information includes configuration, resources, capabilities, and/or load of the plurality of devices and/or software; analyzing the presentation scenario and the collected information by a second ML model to predict a mapping of the plurality of activities to the plurality of devices and/or software of the plurality of participants, based on the configuration, resources, capabilities, and/or load of the plurality of devices and/or software, wherein the mapping indicates, at least, which devices and/or software of the participants is capable to perform which activities of the presentation; and executing the presentation, by the hosting platform, including causing the plurality of devices and/or software of the plurality of participants to perform the mapped activities based on the mapping.

It should be noted that the methods described above may be implemented in a system comprising at least one hardware processor and memory. Alternatively, the methods may be implemented using computer executable instructions of a non-transitory computer readable medium.

The above simplified summary of example aspects serves to provide a basic understanding of the present disclosure. This summary is not an extensive overview of all contemplated aspects, and is intended to neither identify key or critical elements of all aspects nor delineate the scope of any or all aspects of the present disclosure. Its sole purpose is to present one or more aspects in a simplified form as a prelude to the more detailed description of the disclosure that follows. To the accomplishment of the foregoing, the one or more aspects of the present disclosure include the features described and exemplarily pointed out in the claims.

### BRIEF DESCRIPTION OF THE DRAWINGS

The accompanying drawings, which are incorporated into and constitute a part of this specification, illustrate one or more example aspects of the present disclosure and, together with the detailed description, serve to explain their principles and implementations. Like reference numbers and designations in the various drawings indicate like elements.

FIG. 1A is a block diagram of a computer network environment in which an ML-assisted presentation hosting platform operates, according to aspects of the present disclosure.

FIG. 1B is a block diagram illustrating the ML-assisted presentation hosting platform, according to aspects of the present disclosure.

FIG. 2 is a flow diagram of an example method for device mapping configuration hypothesis testing, according to aspects of the present disclosure.

FIG. 3 is a flow diagram of a method for choosing a microphone for a participant of a presentation, according to aspects of the present disclosure.

FIG. 4 is a flow diagram of a method for choosing a speaker for a participant of a presentation, according to aspects of the present disclosure.

FIG. 5 is a flow diagram of a method for choosing a screen sharing device for a participant of a presentation, according to aspects of the present disclosure.

FIG. 6 is a flow diagram of a method for holding a presentation using an ML-based presentation hosting platform, according to aspects of the present disclosure.

FIG. 7 is a flow diagram of a method for training an ML model to map various user devices to activities associated with a presentation scenario, according to aspects of the present disclosure.

FIG. 8 is a block diagram illustrating a system for training ML models of an ML-based presentation hosting platform, according to aspects of the present disclosure.

FIG. 9 is an example of a general-purpose computer system on which aspects of the present disclosure can be implemented.

### DETAILED DESCRIPTION

Exemplary aspects are described herein in the context of a system, method, and computer program product for providing a machine learning (ML)-assisted presentation hosting platform. Those of ordinary skill in the art will realize that the following description is illustrative only and is not intended to be in any way limiting. Other aspects will readily suggest themselves to those skilled in the art having the benefit of this disclosure. Reference will now be made in detail to implementations of the example aspects as illustrated in the accompanying drawings. The same reference indicators will be used to the extent possible throughout the drawings and the following description to refer to the same or like items.

Turning now to the figures, example aspects are depicted with reference to one or more components described herein, where components in dashed lines may be optional.

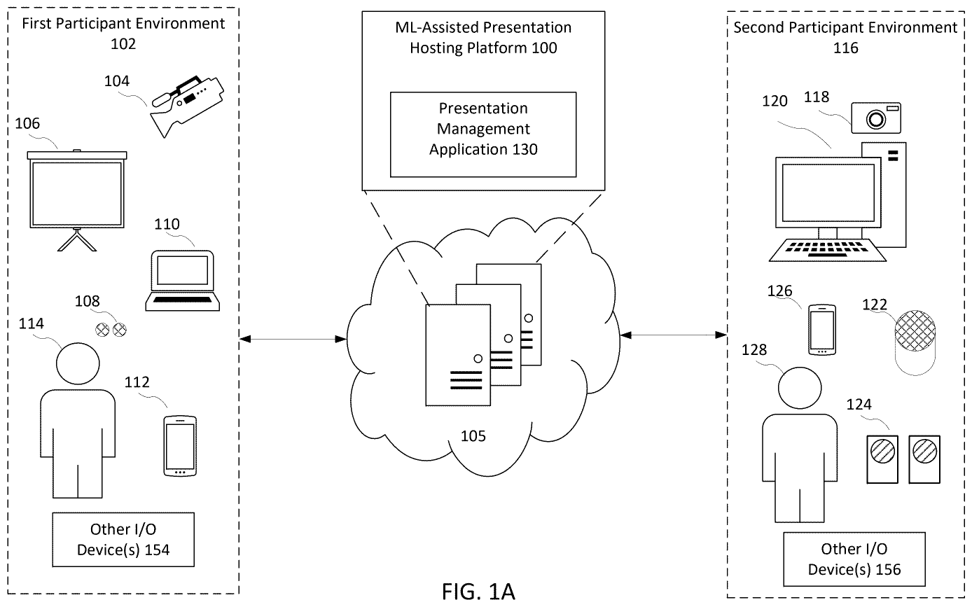

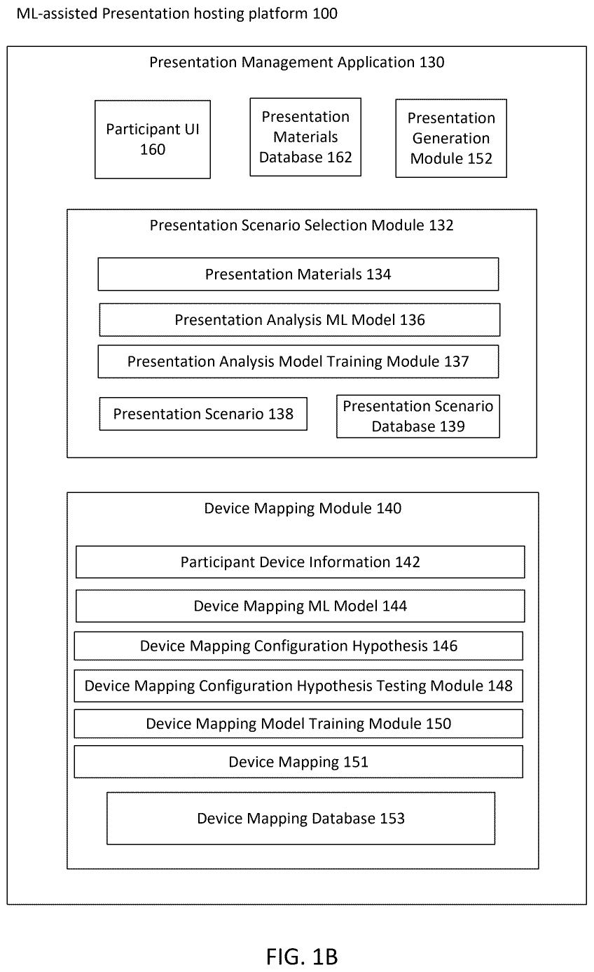

FIG. 1A illustrats a computer network environment in which an ML-assisted presentation hosting platform 100 operates. In one aspect, the presentation hosting platform 100 includes all necessary hardware and software resource for executing a presentation management application 130. In one aspect, the ML-assisted presentation hosting platform 100 may be deployed within a cloud server network 105, such as Amazon Web Services (AWS), Microsoft Azure, or Google Cloud Platform (GCP). This deployment allows users to access the platform via the Internet, leveraging the scalability and reliability of cloud infrastructure. In another aspect, the ML-assisted presentation hosting platform 100 may be implemented as a standalone software application, which users can install on their personal computers, mobile devices, or servers within the first and second participant environments, 102 and 116, respectively. Alternatively, the ML-assisted presentation hosting platform 100 can function as a web application hosted on a local enterprise server, for organizations that have acquired a software license, or on a remote application server of the ML-assisted presentation hosting platform 100 provider. Users can access the ML-assisted presentation hosting platform 100 through a user interface (UI), such as a web browser, facilitating seamless interaction and integration with existing enterprise systems.

In one aspect, the ML-assisted presentation hosting platform 100 offers a presentation management application 130 that comprises a variety of software modules that can be deployed either centrally on a single physical or virtual computer system (e.g., a personal computer, application server, or cloud server) or distributed across multiple computer systems connected via a network, such as the Internet. This presentation management application 130 will be described in greater detail in FIG. 1B. Generally, the presentation management application 130 is designed to facilitate the hosting of presentations, meetings, conferences, teleconferences and other types of online, offline, or hybrid events using a wide range of network-connected devices available to users/participants 114 and 128 in their respective local or remote environments 102 and 116. These devices include, but are not limited to, laptops and PCs running various operating systems (e.g., Windows, macOS, Linux), smartphones and tablets (e.g., Android, iOS), cameras and webcams, projectors, interactive whiteboards, headsets and microphones, as well as virtual and augmented reality (VR/AR) devices, and smart speakers.

It should be noted that although only two participant environments 102 and 116 are shown in FIG. 1A for illustrative purposes, the real number of participants and respective environments may range from tens to hundreds and even thousands. Each participant environment may include a wide range of disparate computing systems, mobile devices, and peripheral devices. For example, the first participant environment 102 may include an iOS laptop computer 110, a video camera 104, a set of earbuds 108 with microphone and speakers, an iOS mobile phone 112, an interactive whiteboard 106, and/or one or more other I/O devices 154 (e.g., wireless presentation remote control, etc.) that are available to the first participant 114 of the presentation. The devices in the first participant environment 102 may be connected to each other and to the Internet using a wired Ethernet network and/or cellular network (not shown). On the other hand, the second participant environment 116 may include a Windows desktop computer 120 with a webcam 118, a microphone 122 and audio speakers 124, an Android smart phone 126, and/or one or more other I/O devices 156 (e.g., microphones, speakers, etc.) that are available to the second participant 128 of the presentation. The devices in the second participant environment 116 may be connected to each other and to the Internet using a Wi-Fi network and/or cellular networks (not shown).

In one aspect, the ML-assisted presentation hosting platform 100, and, in particular, the presentation management application 130, is designed to automatically recognize, pre-configure, test, and intelligently and continuously manage various participant devices, irrespective of their local or remote locations in the participant environments 102 and 116, before and during a presentation, adaptively respond to any device failure, and optimize in real-time the use of network and computing resources of the ML-assisted presentation hosting platform 100 as well as of the participants'devices both in online and offline presentation formats. This advanced functionality of the ML-assisted presentation hosting platform 100 assures an uninterrupted and seamless presentation experience for the organizer/presenter and all participants across all devices available to users, and enhances participant interactivity and engagement across diverse presentation formats and venues.

FIG. 1B illustrates an example implementation of the ML-assisted presentation hosting platform 100 and the presentation management application 130 provided thereon. In one aspect, the presentation management application 130 provides a graphical user interface 160 (e.g. Web interface) that allows a presenter/organizer/host (e.g., participant 114) to upload their presentation materials 134 to the ML-assisted presentation hosting platform 100, where they may be stored in a presentation materials database 162. The presentation materials 134 may include, but are not limited to, presentation slide decks (e.g., PowerPoint, Keynote, Google Slides), supplemental documents (e.g., text documents, PDFs), supplemental multimedia content (e.g., video, audio and VR content), infographics, interactive content (e.g., questionnaire, Q&A, chat, etc.), etc.

In one aspect, the presentation management application 130 includes a presentation generation module 152 that offers a variety of features and functionalities to help users create, edit, and deliver their presentations. For example, users can create/edit individual slides that make up the presentation materials 134, by adding text, images, charts, and other multimedia elements. To that end, the presentation generation module 152 offers a range of design templates and themes to help users create visually appealing presentations. Users can customize slide layouts, backgrounds, fonts, colors, and transitions to match their specific needs. The presentation generation module 152 may also provide collaboration features that allow multiple presenters to work on a presentation simultaneously. In another aspect, the presentation management application 130 may also enable presenters (e.g., participant 114) to set up and control their participant environment 102 by selecting and connecting to the ML-assisted presentation hosting application 130 various devices that the presenter wants to use for the presentation, such as a camera 104, earbuds 108, a desktop or laptop computer 110, a handheld device 112, an interactive board 106, and/or one or more other I/O devices 154 (e.g., microphones, speakers, etc.), as will be described in a greater detail below.

In another aspect, the presentation management application 130 may prompt the presenter/organizer to provide additional information, including, but not limited to, the type of the presentation or meeting (e.g., academic lecture, panel discussion, teleconference, one-on-one meeting, town hall meeting, conference with virtual or life breakout sessions, Q/A session, etc.), the anticipated duration of the presentation or meeting, the expected number of participants, and their contact information (e.g., user IDs on the ML-assisted presentation hosting platform 100, mobile phone numbers, email addresses, etc.), and details about the type and specifics of the presentation hosting venue (e.g., virtual, live or hybrid, specific room number, or building address).

The presentation management application 130 may utilize this additional information to customize and optimize the configuration and deployment of the ML-assisted presentation hosting platform 100 and the participant environments 102 and 116: for example, (1) to allocate the necessary computing and network resources of the ML-assisted presentation hosting platform 100 (e.g., CPU/GPU processing time, memory space, and network bandwidth), for the entire duration of the presentation and for all participants, thus ensuring an uninterrupted and seamless presentation hosting experience for the presenter 102; and (2) to allocate the required computing and network resources within the participants'environments (e.g., computing devices, peripheral devices, CPU processing time, memory space, and network bandwidth), for the entire duration of the presentation for each individual participant 102 and 116, thus ensuring an uninterrupted and smooth delivery of the presentation by the presenter 114 and a seamless consumption experience for the participant(s) 128.

For instance, based on the format and type of meeting, the presentation management application 130 can automatically adjust the user interface 160 to include relevant features such as polling tools for interactive sessions or screen-sharing capabilities for collaborative meetings. The anticipated duration and number of participants may be used to allocate appropriate server resources, ensuring sufficient bandwidth and processing power to handle the expected load, thereby maintaining performance and reliability. Furthermore, the presentation management application 130 can integrate with calendar and scheduling systems to automatically send invitations and reminders to participants, using the provided contact information. It can also interface with security protocols to manage access control, ensuring that only authorized participants can join the session. For hybrid or live venues, the presentation management application 130 can assist in coordinating logistics by interfacing with facility management systems to reserve physical spaces and manage equipment needs.

In one aspect, the presentation management application 130 may include a presentation scenario selection module 132 configured to use a presentation analysis ML model 136 (a trained ML model such as, but not limited to, a large language model (LLM) described later herein) to analyze the presentation materials 134 and any additional information provided by the presenter/organizer and to generate a presentation scenario 138 or to select a previously generated presentation scenario from the presentation scenario database 139. In one example, the presentation scenario 138 may be implemented as a text string, a data structure (e.g., a data file), a script (e.g., JavaScript), a markup file (e.g., XML) containing information about a format/type/content of the presentation, activities associated with the presentation, and one or more devices and/or software necessary for the participants to participate in the activities of the presentation. For example, the format of the presentation may include, but is not limited to, the information about the type, subject, content, duration, venue, and number of participants. The type of the presentation may be indicated as academic lecture, panel discussion, online or offline meeting, virtual teleconference, large conference with virtual or life breakout sessions, Q/A session, or the like. The activities associated with the presentation may include, but are not limited to, displaying a deck of presentation slides, playing video, running an online poll, posing interactive questions for the participants to answer, etc. The devices and software necessary for performing the activities of the presentation may include, but are not limited to, laptop or desktop computers, microphones, speakers, interactive whiteboard, remote control, PowerPoint software, antivirus software, projector, VR headset, etc.

In one aspect, the presentation management application 130 identifies the presentation scenario 138 based on an analysis of uploaded presentation materials 134 and any additional information provided by the presenter or organizer of the presentation. For example, in preparing for a lecture, a teacher may upload various presentation materials 134 (e.g., slides, videos, tests, exercises, participant/learner information, interactive material, etc.) to the ML-assisted presentation hosting platform 100. The presentation analysis ML model 136 (which may be an LLM, for example) analyzes the presentation materials 134 to determine the most suitable presentation scenario 138 for conducting the lecture. For example, the presentation analysis ML model 136 determines the format, structure, and content of the presentation (e.g., text, graphs, and problems) to identify the context of the presentation and key themes and goals of the presentation (e.g., lecture with explanations, testing, interactive discussion, etc.). For example, the presentation analysis ML model 136 may define a use case (e.g., lecture, work meeting, workshop, etc.) based on calendar, meeting content, or user actions.

More specifically, a presentation scenario may indicate whether the subject of a presentation is an academic lecture, a business meeting, a conference, a training course, etc. The presentation scenario may also indicate whether the content of a presentation includes slides, video, audio, interactive content (e.g., questionnaire, Q&A, chat, etc.), etc. The presentation scenario may also indicate whether the format of a presentation is online, offline, or hybrid, whether there are only in person participants, only remote participants, or a mix of in-person and remote participants, etc. The presentation scenario may also indicate the size of a presentation, e.g., the number of participants, the length of the presentation, bandwidth requirements, processing power and memory requirements of participant devices, etc. The presentation scenario may also indicate whether the venue of a presentation includes a classroom, a conference room, geographically distributed participants, etc.

As one non-limiting example aspect, a presentation scenario 138 may indicate, but is not limited to, the following presentation characteristics: (A) the subject of a presentation is an academic lecture (e.g., a math lecture), (B) the content of the presentation includes PowerPoint slides, an interactive board on which the presenter can write and demonstrate concepts, interactive feedback/questions, and evaluations/tests/quizzes, (C) the format of the presentation is hybrid (some learners/participants are present in-person and some others are remotely connected online), (D) the size of the presentation is a one hour lecture with a maximum of 20 in-person learners/participants and 40 remote learners/participants, (E) the venue of the presentation is a lecture hall where the presenter and in-person learners/participants are located and distributed geographic regions where the remote learners/participants are located.

In some aspects, the presentation scenario 138 may indicate one or more device and/or software necessary for execution of the various activities of the presentation. For example, referring to the above non-limiting example aspect, the presentation scenario may correspond to a math teacher conducting a lecture at a university in a hybrid online/offline format, e.g., some learners are present in the classroom while others are connected online. The lesson may involve explaining a new topic, solving problems together, interactive questions, and demonstrating work on a board. The devices used by the teacher may include a laptop (e.g., running Windows) for setting up the presentation, a smartphone (e.g., Android) for running the presentation and recording additional video, a tablet (e.g., iOS) for showing notes on the board and as an additional screen for managing time, a projector to display the presentation in the classroom, a microphone to improve sound quality, and an external camera to record the teacher's work on the board. Further, the devices used by the learners/participants may include a laptop (e.g., running Windows), smartphone (e.g., Android), or tablet (e.g., iOS) for viewing the presentation and interaction with the presentation.

As another non-limiting example aspect, the presentation scenario 138 may indicate that the subject of the presentation is a virtual, live, or hybrid meeting/conference. Accordingly, during the conference, a laptop, smartphone, tablet, etc. may be used for screen sharing, demonstrating content, working with documents, conference management (e.g., start/stop recording, managing participants, adding/removing participants, etc.), video recording and screen recording, as a virtual board (using built-in or external applications for drawing and recording), sound output (using built-in or external speakers), as a content management device (using touchpad, screen, mouse, etc.), gesture camera image post-processing, computations (e.g., for running distributed computing on devices), etc.

Further, during the conference, a smartphone or tablet may also be used as a mobile camera and microphone for recording audio or video from different angles (e.g., a close-up of the speaker or object). For example, a smartphone or tablet may be used as a video camera from a specific point of view, for example, writing activities on a board or demonstrating how to work with objects in the classroom. A smartphone or tablet may also be used as a clicker for presentations (e.g., for switching slides), chat (e.g., fast sending messages), conference control using gestures and sensors, voice commands and assistants (e.g., conference control using voice commands), sharing files and documents (e.g., quickly sending photos or files), as various auxiliary sensors/devices (e.g., light source/flashlight (LED), accelerometer, gyroscope, barometer, compass, GPS, Wi-Fi, Bluetooth, NFC, etc.), as a VR/AR device, as a LIDAR scanner (e.g., to transfer objects from the real world into a 3D digital model), location determination (e.g., for automatic sound control such as echo cancellation), as a fingerprint scanner and face ID for authorization, as an additional screen for notes or as a second screen for the presenter, drawing and annotation (e.g., using a stylus or fingers to write down ideas on a virtual whiteboard), moving interface functions to an external screen (e.g., timer, survey results, engagement module, etc.).

In some aspects, various other specific devices may be used during a presentation. For example, in an aspect, one or more additional cameras may be used for broadcast of written materials, drawings, or real objects. Further, one or more microphones and headsets may be used to improve sound quality. Further, one or more projectors and smartboards may be used for integration with the conference to display information. Further, one or more smart watches may be used for voice commands and assistants, timer, sensors (e.g., acceleration, temperature, humidity, acceleration, pulse), etc. Further, one or more VR/AR helmets may be used for the presentation.

As noted above, the presentation scenario selection module 132 uses the presentation analysis ML model 136 to analyze the presentation materials 134 associated with a presentation, and other information about the presentation/venue/participants if provide by the organizer/presenter, and identify the presentation scenario 138 for the presentation. The presentation analysis ML model 136 is a trained ML model such as, but not limited to, an LLM. LLMs are advanced artificial intelligence systems designed to understand and generate human-like text. These models are trained on vast amounts of data, enabling them to comprehend context, recognize patterns, and produce coherent and contextually relevant responses. LLMs are utilized in various applications, including chatbots, content creation, and language translation. Their ability to process and generate natural language makes them powerful tools for enhancing communication and automating tasks that require language understanding. However, the LLM modules must first go through preparing (which may include training, retraining, distillation, fine-tuning, etc.) to teach each LLM model to perform their respective specific tasks. As a non-limiting example, the LLM models may incorporate one of the machine learning models listed below.

A transformer is a deep learning architecture used in LLMs. A transformer has an encoder/decoder structure with numerous stacked multi-head attention layers and feed forward network layers. This architecture allows the model to process and generate text effectively, capturing long-range dependencies and contextual information. Transformers are well-suited for tasks like natural language processing and image classification and generation. Common examples of transformer models are generative pre-trained transformers (GPTs) and Bidirectional Encoder Representations from Transformers (BERTs).

A classification model is a type of machine learning model that is designed to predict the category or class to which a given data point belongs to. A classification model works by analyzing input features and assigning them to one of several predefined labels. These models are trained on labeled data, where the correct category is known, and they learn patterns that allow them to make predictions on new, unseen data. Examples of classification models include at least a regression model used for binary classification, a decision tree used to predict class by splitting data based on feature values, support vector machines (SVMs) configured to perform classification by finding the best boundary between classes, and neural networks.

In an aspect, the presentation analysis ML model 136 may include one or more neural networks that are trained to automatically identify the presentation scenario 138 based on analyzing the presentation materials 134. Neural networks are a class of machine learning models inspired by the structure and functioning of the human brain. They consist of interconnected nodes, called neurons, or artificial neurons, organized into layers. Neural networks are capable of learning complex patterns and representations from data. The presentation analysis ML model 136 used for identifying the presentation scenario 138 may include one or more of the following neural networks: encoder/decoder transformer neural networks, convolution neural networks (CNNs), recurrent neural networks (RNNs), long short-term memory (LSTM) networks, gated recurrent unit (GRU) networks, autoencoders, and generative adversarial networks (GANs).

A CNN is specialized for processing grid-like data, such as images, and employs convolutional layers to learn spatial hierarchies of features, reducing the need for manual feature engineering. CNNs are well-suited for tasks like image classification, object detection, and image generation. An RNN is designed for sequential data, where the order of inputs matters. An RNN includes loops in the network architecture to allow information to persist, and is useful for tasks like natural language processing, speech recognition, and time-series prediction. An LSTM network is an extension of an RNN designed to overcome the vanishing gradient problem. LSTMs have memory cells that can store and retrieve information over long sequences, making them effective for capturing long-term dependencies in sequential data. A GRU network is similar to LSTMs and is another type of RNN with mechanisms to address the vanishing gradient problem. GRUs have a simpler architecture with fewer parameters compared to LSTMs. An autoencoder is a type of neural network used for unsupervised learning and dimensionality reduction, and consists of an encoder that compresses input data into a lower-dimensional representation (encoding) and a decoder that reconstructs the original input from the encoding. A GAN comprises a generator and a discriminator trained simultaneously through adversarial training. The generator aims to generate realistic data, while the discriminator tries to distinguish between real and generated data. A GAN is widely used for image and content generation tasks.

The presentation scenario selection module 132 includes a presentation analysis model training module 137 configured to train the presentation analysis ML model 136 using one or more training datasets. For analysis tasks such as identifying the presentation scenario 138 based on the presentation materials 134, an untrained presentation analysis ML model 136 will first analyze data from a training set to “learn” which presentation material correspond to which presentation scenarios. As an example, the training dataset may include at least a plurality of different presentation materials and a plurality of different presentation scenarios. During preparing (which may include training, retraining, distillation, fine-tuning, etc.), the training dataset are input through the untrained presentation analysis ML model 136. The results from the untrained presentation analysis ML model 136 are then compared with known dataset results using the corresponding labels identifying correct presentation scenarios (e.g., PowerPoint Slides, questionnaires, and other presentation material indicating the presentation scenario as an academic lecture with hybrid learners and with interactive content). It should be noted that the input to the trained presentation analysis ML model 136 will be data from the training dataset.

For every input training sample from the training dataset, the trained presentation analysis ML model 136 will produce a prediction consisting of values representing a probability that a particular presentation scenario is correctly identified. The trained presentation analysis ML model 136 then uses a loss function that quantifies the error between the predicted output and the ground truth for a given training sample. In other words, the loss function can be used to guide the learning process by updating the network weights in a way that improves the accuracy of future predictions. This process may continue until the difference between the prediction and the correct targets is minimal. In some examples, an appropriate loss function is used, such as Mean Squared Error (MSE) for regression tasks or a Cross-Entropy Loss for classification tasks.

Once the presentation analysis ML model 136 is trained, the trained presentation analysis ML model 136 may be used for inference, e.g., for identifying the presentation scenarios. During inference, the trained presentation analysis ML model 136 does not re-evaluate or adjust the layers of the neural network based on the results. Instead, the inference applies knowledge from the trained neural network and uses it to infer a result (e.g., identify a presentation scenario). Accordingly, when a new unknown dataset (e.g., new presentation material) is input through the trained presentation analysis ML model 136, the trained presentation analysis ML model 136 outputs a prediction of an accuracy of presentation scenario identification based on predictive accuracy of the presentation analysis ML model 136.

Once the presentation scenario 138 is identified, the ML-assisted presentation hosting platform 100 may execute a device mapping module 140 configured to use a device mapping ML model 144 to create and test a device mapping configuration hypothesis 146 which is a proposed mapping of the presentation scenario activities to the available participant user devices. The device mapping ML model 144 may do so based on the presentation scenario 138, participant device information 142 (resources and/or capabilities of the available participant user devices), and system load. To that end, the device mapping module 140 may collect information about devices available in the participant environments 102 and 116.

Accordingly, the presentation management module 100 may execute a device mapping configuration hypothesis testing module 148 configured to test the device mapping configuration hypothesis 146 and change it if needed. In one example, the device mapping configuration hypothesis testing module 148 uses software agents. The device mapping configuration hypothesis testing module 140 tests the device mapping configuration hypothesis 146 to determine whether each device works correctly for its assigned tasks/activities. For example, in the academic lecture scenario, the device mapping ML model 144 performs testing and validation of the device mapping configuration hypothesis 146 by: checking the quality of the sound and video, detecting any echo or other audio issues, verifying that all devices are correctly connected to the ML-assisted presentation hosting platform 100 (e.g., microphones, cameras, screen sharing devices, etc.), and providing recommendations for installing software. The testing may involve running the presentation in a test mode and asking one or more users to confirm successful execution of the presentation and satisfactory performance of all devices, systems and applications involved in the presentation.

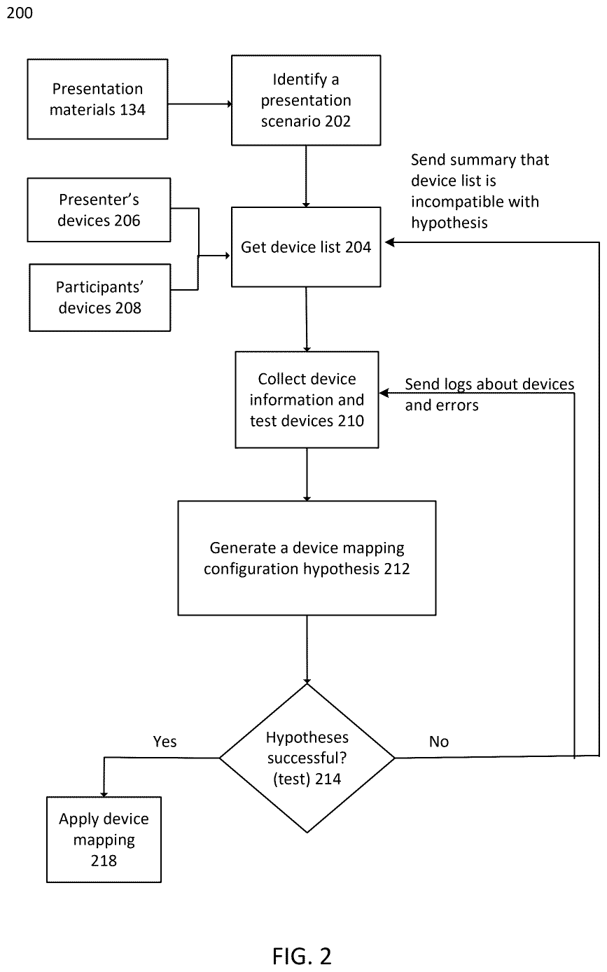

Once a successful device mapping configuration hypothesis 146 is identified, a corresponding device mapping 151 can be generated to map the presentation scenario activities to the available participant user devices. Further details of device mapping configuration hypothesis testing are provided with reference to FIG. 2 described later herein.

The device mapping ML model 144 may be a trained ML model such as any of the ML model types described herein above, e.g., transformer models, neural networks, etc., and the device mapping module 140 includes a device mapping model training module 150 configured to train the device mapping ML model 144 using one or more training datasets. For analysis tasks such as creating a mapping of the presentation scenario activities to the available user devices, an untrained device mapping ML model 144 will first analyze data from a training set to “learn” which presentation scenario and device information corresponds to which device mapping. As an example, the training dataset may include at least a plurality of different presentation scenarios, a plurality of different device information (resources and/or capabilities of the available participant user devices), and a plurality of different device mappings. More specifically, the input for training the device mapping ML model 144 may include a plurality of presentation scenarios and a plurality of devices and/or software with different configuration, resources, capabilities, and/or load, including devices and/or software that are capable and/or not capable of performing each activity indicated in the presentation scenarios. The output for device mapping ML model 144 may include a mapping between the one or more presentation scenarios and a plurality of devices and/or software that are capable of performing each activity indicated in the presentation scenarios.

During preparing (which may include training, retraining, distillation, fine-tuning, etc.), the training dataset are input through the untrained device mapping ML model 144. The results from the untrained device mapping ML model 144 are then compared with known dataset results using the corresponding labels identifying correct device mappings (e.g., for a presentation scenario requiring display of slides and a live video of the presenter, and for a user having a laptop and a smartphone, use the laptop for display of the slides and use the smartphone for streaming the live video of the presenter). It should be noted that the input to the trained device mapping ML model 144 will be data from the training dataset.

For every input training sample from the training dataset, the trained device mapping ML model 144 will produce a prediction consisting of values representing a probability that a particular device mapping is correctly identified. The trained device mapping ML model 144 then uses a loss function that quantifies the error between the predicted output and the ground truth for a given training sample. In other words, the loss function can be used to guide the learning process by updating the network weights in a way that improves the accuracy of future predictions. This process may continue until the difference between the prediction and the correct targets is minimal. In some examples, an appropriate loss function is used, such as Mean Squared Error (MSE) for regression tasks or a Cross-Entropy Loss for classification tasks.

Once the device mapping ML model 144 is trained, the trained device mapping ML model 144 may be used for inference, e.g., for identifying a device mapping. During inference, the trained device mapping ML model 144 does not re-evaluate or adjust the layers of the neural network based on the results. Instead, the inference applies knowledge from the trained neural network and uses it to infer a result (e.g., identify a device mapping). Accordingly, when a new unknown dataset (e.g., new presentation scenario and device information) is input through the trained device mapping ML model 144, the trained device mapping ML model 144 outputs a prediction of an accuracy of device mapping identification based on predictive accuracy of the device mapping ML model 144.

After creating the device mapping 151, the presentation management module 100 may execute a presentation generation module 152 configured to hold the presentation by utilizing participant devices available in the first participant environment 102 and the second participant environment 116 according to the device mapping 151.

Referring now to both FIGS. 1A-1B and FIG. 2, a method 200 provides an example aspect of device mapping configuration hypothesis testing. In various implementations, the method 200 is performed by a device with one or more processors and non-transitory memory. In some implementations, the method 200 is performed by processing logic, including hardware, firmware, software, or a combination thereof. In some implementations, the method 200 is performed by a processor executing code stored in a non-transitory computer-readable medium (e.g., a memory). Some aspects of the method 200 are described below with reference to one non-limiting example aspect related to an academic lecture with presentation, where the context includes a teacher giving a lecture in an offline classroom using a projector, and where some of the learners are present in-person and some are connected online. However, it should be noted that the applicability of the method 200 is not limited to this specific scenario.

At 202, the ML-assisted presentation hosting platform 100 identifies a presentation scenario 138 based on an analysis of uploaded presentation materials 134. For example, in preparing for a lecture, a teacher may upload various presentation materials 134 (e.g., slides, videos, tests, exercises, participant/learner information, interactive material, etc.) to the ML-assisted presentation hosting platform 100. The presentation analysis ML model 136 (which may be an LLM, for example) analyzes the presentation materials 134 to determine the most suitable presentation scenario 138 for conducting the lecture. For example, the presentation analysis ML model 136 determines the structure and content of the presentation, (e.g., text, graphs, and problems) to identify the context of the presentation and key themes and goals of the presentation (e.g., lecture with explanations, testing, interactive discussion, etc.). For example, the presentation analysis ML model 136 may define a use case (e.g., lecture, work meeting, workshop, etc.) based on calendar, meeting content, or user actions.

In one non-limiting aspect, for example, the presentation analysis ML model 136 may identify that the presentation has a lecture format, and additional tests and assignments may indicate the need for interactive elements (e.g., problem-solving, polls, etc.). The presentation analysis ML model 136 determines lecture goals, e.g., recognizes that the main focus is on explaining and solving math problems involving both online and in-class learners. Based on the analysis, the presentation analysis ML model 136 suggests the presentation scenario 138 to be: “Lecture with activities and interactive exercises, including presentation of a new topic with display on the projector, working on the board, and solving problems, and interaction with both online and in-person students.”

At 204, the device mapping module 140 obtains a list of presenter's devices 206 (any devices accessible to a presenter of the presentation) and participants'devices 208 (any devices accessible to participants of the presentation), and at 210 the device mapping module 140 collects device information and tests the devices, e.g., checks the quality of the devices. The device information may include, for example, device type and model, software/hardware information/capabilities of the devices (e.g., operating system, camera, camera quality, microphone, screen size and resolution, battery capacity and charge level, available sensors and auxiliary devices, etc.), as well as user preferences and the current load on the devices (e.g., RAM and CPU usage on a laptop, tablet, smartphone, etc.) and the current load on the communication channels of the devices. In one aspect, the device mapping module 140 may recommend and install on the user's devices any necessary software updates or device drivers that are required for viewing the presentation and operating all required peripheral devices (e.g., microphones, cameras, whiteboards, VR headsets, etc.). In another aspect, the device mapping module 140 may run any necessary antivirus/malware tests on the devices and install any necessary security patches on the devices'OS or antivirus software to make sure that the devices are clean of any malware that can adversely affect operation of the devices during the presentation or potentially spread to other connected devices during the presentation.

In an aspect, for example, the device mapping module 140 may use a browser or an application on a user's device to collect a list of connected devices (e.g., laptop, tablet, smartphone, external microphone, projector, and external camera, etc.), and tests the devices for their status and quality (e.g., tests microphone sound, camera video quality, screen sharing capability, etc.). For example, for microphones, the device mapping module 140 may perform sound quality check. For cameras, the device mapping module 140 may perform resolution and field of view check. For speakers, the device mapping module 140 may perform volume and sound quality check. For screen sharing devices, the device mapping module 140 may analyze open applications and test connection to the projector.

At 212, the device mapping ML model 144 generates a device mapping configuration hypothesis 146 that indicates a mapping of devices and their resources to various tasks identified in the presentation scenario 138. In an aspect, the device mapping ML model 144 is configured to compare presentation scenario requirements (e.g., need for video, use of interactive whiteboard, etc.) with device capabilities, and provide a suggestion of optimal use cases. In an aspect, the device mapping ML model 144 creates and ranks a list of recommended roles for each connected device (e.g., “use your smartphone as a clicker,” “use your tablet to stream video”), and interactively offers options to the user (e.g., “We recommend using your tablet to share the whiteboard. Would you like to set this up automatically?”). The device mapping ML model 144 may be continually trained and improved. Specifically, for example, the device mapping model training module 150 may continually update the device mapping ML model 144 based on user preferences and historical data (e.g., which scenario/mapping combinations were used most often, whether the scenario/mapping combinations were successful, etc.). Accordingly, the device mapping ML model 144 may adapt by learning from user data and preferences, thus allowing the devices to be optimally allocated for different presentation scenarios.

As one non-limiting example aspect pertaining to the academic lecture scenario, the device mapping ML model 144, which may be a neural network, an algorithm, or a machine learning model (e.g., a regression model, an encoder-decoder, or an autoencoder) trained on previously conducted lectures, evaluates the system performance/resources to assess if the devices can handle the proposed tasks. For example, the device mapping ML model 144 may check the current load on the teacher and learner devices (e.g., RAM and CPU usage on laptop, tablet, and smartphone of the teacher and the learners) and the current load on the communication channels of the devices. The device mapping ML model 144 suggests a configuration that matches a device's capacity (including input/output and computational load) to a certain task. In some aspects, for example, if the devices are heavily loaded (e.g., high CPU or RAM usage), a less resource-intensive device mapping configuration hypothesis is proposed, e.g., by lowering video resolution or disabling additional cameras, by using only one device to handle both audio and video processing, etc.

In one non-limiting aspect, for example, for microphone functionality for the teacher, the device mapping ML model 144 may choose the best sound configuration to be a smartphone of the teacher because its microphone is closer to the teacher and has better sound quality. For speaker functionality for in-person learners, learner laptop speakers may be used for better sound distribution in the classroom. For camera functionality for the teacher, an external camera may be selected for capturing a smartboard, as it has the best resolution and viewing angle, or a tablet may be selected for capturing the board if the tablet has a wide-angle lens and better image quality. For screen sharing functionality for the teacher, a laptop of the teacher may be used for connecting to a projector so the presentation can be displayed on the screen for in-class learners. A tablet of the teacher may also be used to track time and to display poll results. Online learner/participant smartphones may also be switched to VR/AR.

The device mapping ML model 144 may be a regression model trained based on data from previously conducted lectures with similar scenarios and devices. The device mapping ML model 144 may be trained using labeled data as described previously. Specifically, the device mapping ML model 144 may be trained using data from previous successful and unsuccessful configurations. This data may include devices that were used (e.g., which microphone, camera, speakers, etc., was used), the system load and device performance, equipment capacity and its impact on the quality of the lecture, etc. The device mapping ML model 144 is trained to predict the most suitable configuration (the most suitable device for each task) based on the current set of available devices in the participant environments and the predicted presentation scenario 138.

At 214 the device mapping configuration hypothesis testing module 140 tests the device mapping configuration hypothesis 146 to determine whether each device works correctly for its assigned tasks/activities. For example, in the academic lecture scenario, the device mapping ML model 144 performs testing and validation of the device mapping configuration hypothesis 146 by: checking the quality of the sound and video, detecting any echo or other audio issues, verifying that all devices are correctly connected to the ML-assisted presentation hosting platform 100 (e.g., microphones, cameras, screen sharing devices, etc.), and providing recommendations for installing software. The testing may involve running the presentation in a test mode and asking one or more users to confirm successful execution of the presentation and satisfactory performance of all devices, systems and applications involved in the presentation.

If the testing of the device mapping configuration hypothesis 146 is successful, at 218 the device mapping module 140 applies the corresponding device mapping 151. If the testing of the device mapping configuration hypothesis 146 is not successful, the device mapping module 140 loops back to 204 and sends a summary indicating that the device list is incompatible with the presentation scenario 138, so that a new device mapping configuration hypothesis can be generated. The device mapping module 140 also sends logs about the devices and errors to be used at 210 for generating the new device mapping configuration hypothesis.

For example, in the academic lecture scenario, if the testing of the device mapping configuration hypothesis 146 is successful, the device mapping module 140 applies the device configuration and the teacher sees all the devices and their roles on the UI dashboard of the platform 100. For example, the teacher may see that their smartphone is used as microphone, their laptop is used for presentation sharing and conference management, their tablet is used for additional features (e.g., time tracking, displaying poll results, etc.), and an external camera is used for streaming actions performed on the board. The teacher can view the data on the dashboard and, if necessary, manually adjust the configuration (e.g., switch the camera, change the microphone, etc.). Also, through the dashboard, the teacher can test the devices (e.g., check sound or camera image quality). The presentation generation module 152 can then conduct the presentation (lecture) and perform interactive activities using the device as assigned to various tasks.

In some aspects, after a device mapping configuration hypothesis 146 is successfully tested and the corresponding device mapping 151 is applied, the device mapping module 140 stores the device mapping 151 for the presentation scenarios 138 and presentation location, so that the device mapping 151 can be used for similar scenarios/locations to allow faster configuration in the future. For example, in the academic lecture scenario, if a device mapping configuration hypothesis 146 is successful, the device mapping module 140 stores the device mapping 151 in a device mapping database 153 as a new device mapping along with the current location/room (e.g., indicated manually or based on GPS data or room identification) and configuration parameters (e.g., which devices were used, the system load level, etc.). The system load level (e.g., high, medium, low) may also be saved so that the device mapping module 140 can consider the load when selecting a device mapping in the future. Accordingly, for example, if the teacher returns to the same classroom, the device mapping module 140 can offer the stored information for quick setup.

For example, for a subsequent presentation, after identifying the presentation scenario at 202, the device mapping module 140 may first search the device mapping database 153 for previously-stored device mappings, and may also check the device loads. For example, in the academic lecture scenario, the device mapping module 140 may determine the current location/room (e.g., indicated manually or based on GPS data or room identification), e.g., identify that the teacher is in a classroom where similar lessons have been held before. The device mapping module 140 then searches the device mapping database 153 for a previously-stored device mapping for this location/room and a similar content (e.g., a previous math lesson in this classroom), where the previously-stored device mapping has been successfully used before with the same set of devices.

Accordingly, for conservative use of resources, if a suitable previously-stored device mapping for a similar scenario and location/room is found in the device mapping database 153, the device mapping module 140 offers that device mapping to the teacher for quick device setup, thus skipping the steps of collecting device data and generating and testing a device mapping configuration hypothesis. In some aspects, along with checking the previously-stored device mappings, the device mapping module 140 may also evaluate/analyze system resources such as the load on the system (e.g., CPU usage, RAM usage, etc.) and device capacity. If the system is heavily loaded, the device mapping module 140 may suggest a less resource-intensive configuration, such as using a lower resolution camera or reducing video quality. The device mapping module 140 then provides the proposal for device mapping.

If the teacher accepts the device mapping proposal, or if a suitable previously-stored device mapping does not exist in the device mapping database 153, the device mapping module 140 continues with collecting device data and generating and testing a device mapping configuration hypothesis as described before.

Accordingly, ML-driven algorithms help automate the selection of the academic lecture scenario, device connection, and optimization of their usage. This allows the teacher to focus on the content of the lesson without worrying about the technical aspects of setting up the equipment/devices.

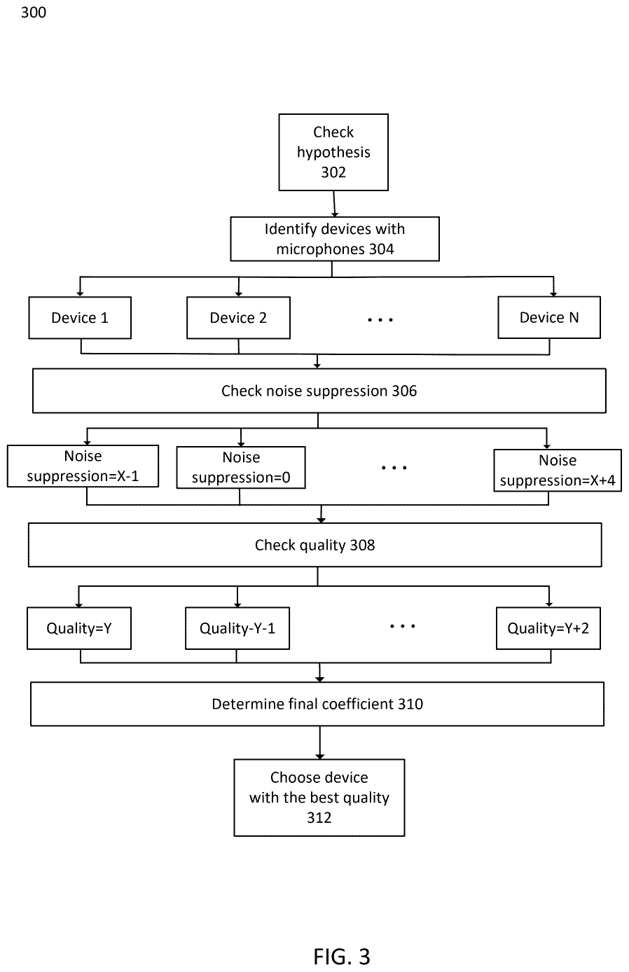

As described above, some present aspects test the available devices for a specific device mapping configuration hypothesis, such as microphones, speakers, screen sharing devices, etc. FIG. 3 is a flow diagram of an example method 300 for testing microphones for a participant of a presentation in a specific device mapping configuration hypothesis, including determining the technical ability to connect to various devices and assessing the quality of the device microphones based on technical parameters such as noise suppression, directionality, frequency range, etc. In various implementations, the method 300 is performed by a device with one or more processors and non-transitory memory. In some implementations, the method 300 is performed by processing logic, including hardware, firmware, software, or a combination thereof. In some implementations, the method 300 is performed by a processor executing code stored in a non-transitory computer-readable medium (e.g., a memory).

At 302, the device mapping module 140 checks the device mapping configuration hypothesis, and, at 304, the device mapping module 140 identifies all connected devices that have microphones (e.g., laptops, smartphones, tablets, etc.), such as Device 1, Device 2, . . . , Device N. At 306, the device mapping module 140 checks the noise suppression of each device, e.g., determine that the value of noise suppression of Devices 1, 2, . . . , N is X−1, 0, . . . , X+4, respectively. Further, at 308, the device mapping module 140 checks the quality of each device by conducting a local sound test (e.g., recording and playback of a test signal) and evaluates the physical distance to the presenter (e.g., based on the location of the devices). For example, the device mapping module 140 may determine that the quality of Devices 1, 2, . . . , N is Y, Y−1, . . . , Y+2, respectively. At 310 the device mapping module 140 calculates a final coefficient for each device based on the assessed quality values. For example, the coefficient may be a linear function of the assessed quality values. At 312 the device mapping module 140 chooses the device with the best coefficient. For example, the device mapping module 140 may select the microphone with the best sound quality and closest proximity to the presenter, for example, a smartphone microphone on a table where the presenter is located. Optionally, dynamic microphone switching may be implemented to use multiple microphones depending on which one has better quality. Accordingly, If the presenter moves, dynamic switching between microphones is activated (e.g., switching to a tablet microphone if the presenter moves closer to the tablet).

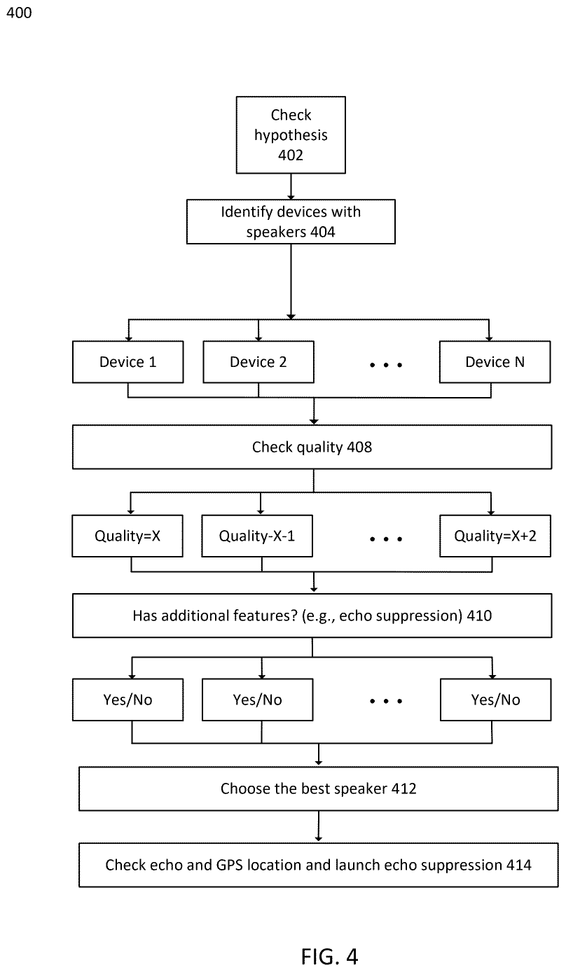

FIG. 4 is a flow diagram of an example method 400 for testing the speakers for a participant of a presentation in a specific device mapping configuration hypothesis, including determining the technical ability to connect to the speakers and performing quality analysis of the technical parameters of the speakers (e.g., power, frequency range, stereo availability, etc.). In various implementations, the method 400 is performed by a device with one or more processors and non-transitory memory. In some implementations, the method 400 is performed by processing logic, including hardware, firmware, software, or a combination thereof. In some implementations, the method 400 is performed by a processor executing code stored in a non-transitory computer-readable medium (e.g., a memory).

At 402 the device mapping module 140 checks the device mapping configuration hypothesis, and at 404 the device mapping module 140 identifies all connected devices that have speakers (e.g., laptops, smartphones, tablets, etc.), such as Device 1, Device 2, . . . , Device N. At 408 the device mapping module 140 checks speaker quality, e.g., by performing a local test for volume and sound quality of the devices that have audio out. For example, the device mapping module 140 may determine that Devices 1, 2, . . . , N have a quality equal to X, X−1, . . . , X+2, respectively. At 410 the device mapping module 140 determines whether each of the devices has additional features such as echo suppression.

At 412 the device mapping module 140 chooses the best speaker. For example, if a lecture is taking place in a large hall, the device mapping module 140 may suggest using participant laptop speakers for even sound distribution. Optionally, proximity to the participant (when using participant device speakers) may be considered for echo cancellation. The device mapping module 140 may also select external speakers if they are connected (e.g., via Bluetooth).

At 414 the device mapping module 140 checks echo and GPS location of the chosen devices and launches echo suppression. For example, echo suppression may be turned on to avoid the effect of reverberation. For example, the device mapping module 140 may check microphone-speaker pairs for possible echo, and turn on echo cancellation when searching for a speaker and microphone combination. When an echo is detected, the device mapping module 140 may activate an echo cancelation algorithm, which may disable unnecessary speakers or microphones, enable software filters to minimize reverberation, etc.

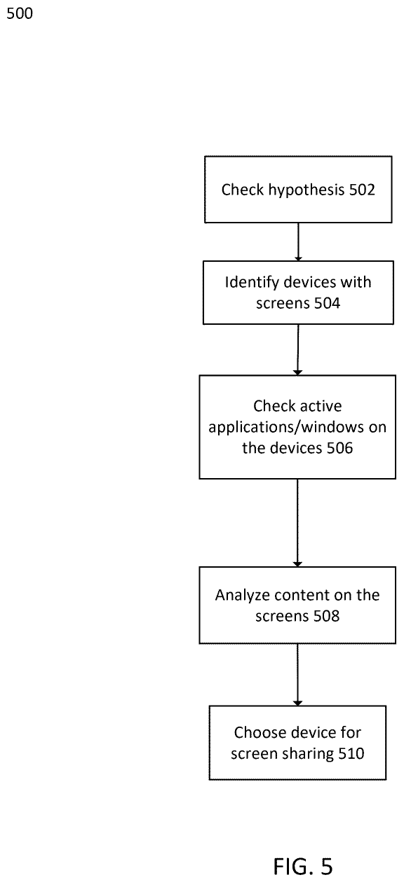

FIG. 5 is a flow diagram of an example method 500 for screen sharing for a participant of a presentation in a specific device mapping configuration hypothesis, based on analysis of the screens of connected devices. In various implementations, the method 500 is performed by a device with one or more processors and non-transitory memory. In some implementations, the method 500 is performed by processing logic, including hardware, firmware, software, or a combination thereof. In some implementations, the method 500 is performed by a processor executing code stored in a non-transitory computer-readable medium (e.g., a memory).

At 502 the device mapping module 140 checks the device mapping configuration hypothesis, and at 504 the device mapping module 140 identifies all connected devices that have screens (e.g., laptops, smartphones, tablets, etc.). At 506 the device mapping module 140 checks active applications/windows on each device, and at 508 the device mapping module 140 analyzes the content on the screen (e.g., uses the device mapping ML model 144 to recognize presentations, text documents, active windows, etc.). Based on the analysis, at 510 the device mapping module 140 chooses a device for screen sharing.

For example, in the academic lecture scenario, if a presentation is open on a laptop, the device mapping module 140 may offer to use the laptop to share the screen to the projector. The teacher may be given the opportunity to manually confirm the selection of the screen for sharing or change it. The device mapping module 140 may also perform analysis of the content on the screens offered for viewing to the participants by the teacher (several sources) to make a decision on sharing. Specifically, the device mapping module 140 may determine screen content (e.g., uses the device mapping ML model 144 which may be a neural network to determine whether the content is significant or not based on text patterns, presentation, etc.) and active changes and screen focus, and determine which screen the sound is coming from (for example, playing a video).

In some aspects, the device mapping module 140 may similarly perform analysis of camera image quality from the devices connected to the presentation. Specifically, the device mapping module 140 may determine the technical ability to connect to the cameras, and may use the device mapping ML model 144 to analyze the technical parameters of the cameras to recommend the best option. In some aspects, the device mapping module 140 may also determine proximity of the cameras to the presenter and determine the best picture quality (e.g., performs testing).

In some aspects, the device mapping module 140 may provide real-time dynamic switching of video and audio devices, e.g., switching between devices depending on changing conditions. For example, for video functionality in the academic lecture scenario, if the teacher moves, the device mapping module 140 may suggest switching to another camera if its quality or position is better. For audio functionality, if the noise level changes, the device mapping module 140 may automatically switch to another microphone with higher sensitivity or noise reduction. The device mapping module 140 may also display virtual controls for media devices.

In some optional aspects, the device mapping module 140 may consider additional parameters to improve the device mapping. For example, in the academic lecture scenario, the device mapping module 140 may provide a teacher control interface, where the teacher can set device priorities manually (e.g., select the main microphone or camera). The teacher control interface may also provide the ability to set a conference scenario on the dashboard, which automatically determines important parameters (e.g., lecture, group work, activity in the room, etc.).

In some optional aspects, the device mapping module 140 may test the devices when the devices are first connected. For example, when a new device is connected, the device mapping module 140 tests the quality of its components and suggests using the new device if it is better than the existing connected devices. For example, echo testing may be performed when additional speakers and microphones are connected.

In some optional aspects, the device mapping module 140 may support multitasking. For example, the device mapping module 140 may provide the ability to use multiple devices simultaneously (e.g., screen sharing from one device, microphone from another device, camera from a third device, etc.).

In some optional aspects, the device mapping ML model 144 in the device mapping module 140 may support integration with external information sources. For example, the device mapping ML model 144 may use external databases to update information about new devices and their characteristics to continually offer up-to-date recommendations.

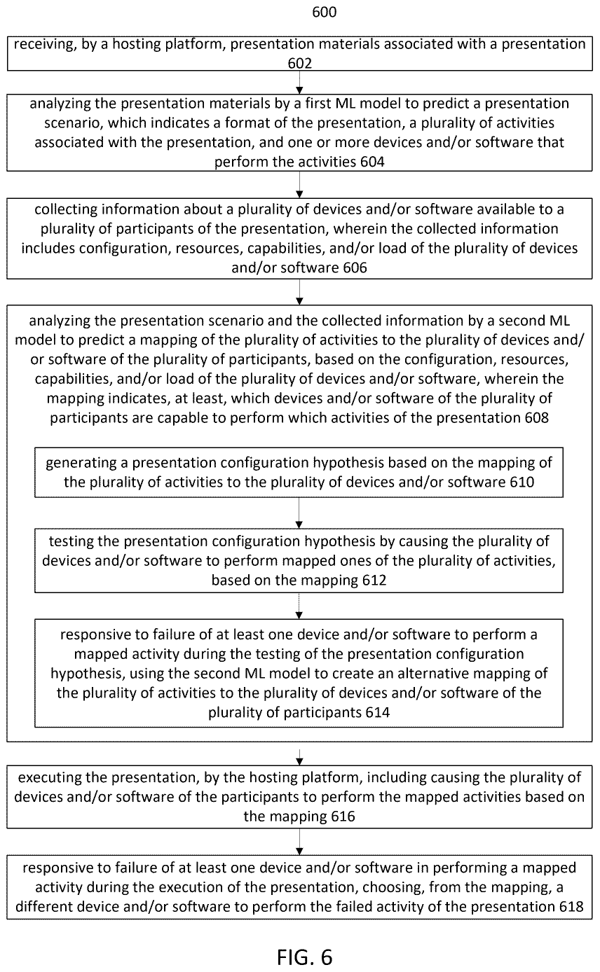

FIG. 6 is a flow diagram of a method 600 for holding a presentation using an ML-based presentation hosting platform, according to aspects of the present disclosure. At step 602, the hosting platform receives presentation materials associated with a presentation. At step 604, the hosting platform analyzes the presentation materials by a first ML model to predict a presentation scenario. In one aspect, the presentation scenario indicates a format of the presentation, a plurality of activities associated with the presentation, and one or more devices and/or software that perform the activities. At step 606, the hosting platform collects information about a plurality of devices and/or software available to a plurality of participants of the presentation. In one aspect, the collected information includes configuration, resources, capabilities, and/or load of the plurality of devices and/or software. At step 608, the hosting platform analyzes the presentation scenario and the collected information by a second ML model to predict a mapping of the plurality of activities to the plurality of devices and/or software of the plurality of participants, based on the configuration, resources, capabilities, and/or load of the plurality of devices and/or software. In one aspect, the mapping indicates, at least, which devices and/or software of the plurality of participants are capable to perform which activities of the presentation. At step 610, the hosting platform generates a presentation configuration hypothesis based on the mapping of the plurality of activities to the plurality of devices and/or software. At step 612, the hosting platform tests the presentation configuration hypothesis by causing the plurality of devices and/or software to perform mapped ones of the plurality of activities, based on the mapping. At step 614, responsive to failure of at least one device and/or software to perform a mapped activity during the testing of the presentation configuration hypothesis, the hosting platform uses the second ML model to create an alternative mapping of the plurality of activities to the plurality of devices and/or software of the plurality of participants.

At step 616, the hosting platform executes the presentation by causing the plurality of devices and/or software of the participants to perform the mapped activities based on the mapping. Finally, at step 618, responsive to failure of at least one device and/or software in performing a mapped activity during the execution of the presentation, the hosting platform chooses, from the mapping, a different device and/or software to perform the failed activity of the presentation.

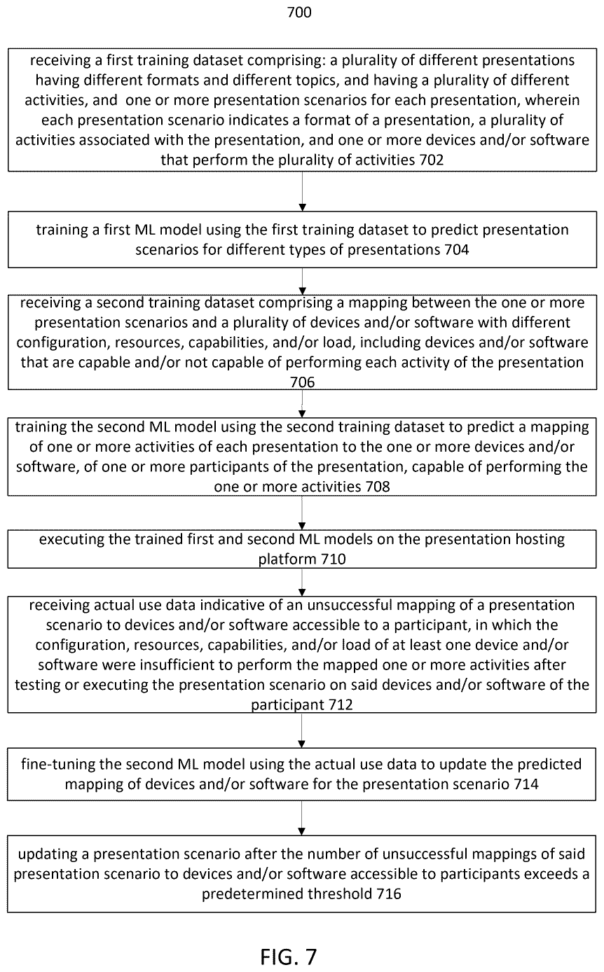

FIG. 7 is a flow diagram of a method 700 for training an ML-based presentation hosting platform to map various user devices to activities associated with a presentation scenario, according to aspects of the present disclosure. At step 702, the hosting platform receives a first training dataset comprising: a plurality of different presentations having different formats and different topics, and having a plurality of different activities, and one or more presentation scenarios for each presentation. In one aspect, each presentation scenario indicates a format of a presentation, a plurality of activities associated with the presentation, and one or more devices and/or software that perform the plurality of activities. At step 704, the hosting platform trains a first ML model using the first training dataset to predict presentation scenarios for different types of presentations. At step 706, the hosting platform receives a second training dataset comprising a mapping between the one or more presentation scenarios and a plurality of devices and/or software with different configuration, resources, capabilities, and/or load, including devices and/or software that are capable and/or not capable of performing each activity of the presentation. At step 708, the hosting platform trains the second ML model using the second training dataset to predict a mapping of one or more activities of each presentation to the one or more devices and/or software, of one or more participants of the presentation, capable of performing the one or more activities. At step 710, the hosting platform executes the trained first and second ML models. At step 712, the hosting platform receives actual use data indicative of an unsuccessful mapping of a presentation scenario to devices and/or software accessible to a participant, in which the configuration, resources, capabilities, and/or load of at least one device and/or software were insufficient to perform the mapped one or more activities after testing or executing the presentation scenario on said devices and/or software of the participant. At step 714, the hosting platform fine-tunes the second ML model using the actual use data to update the predicted mapping of devices and/or software for the presentation scenario. At step 716, the hosting platform updates a presentation scenario after the number of unsuccessful mappings of said presentation scenario to devices and/or software accessible to participants exceeds a predetermined threshold.

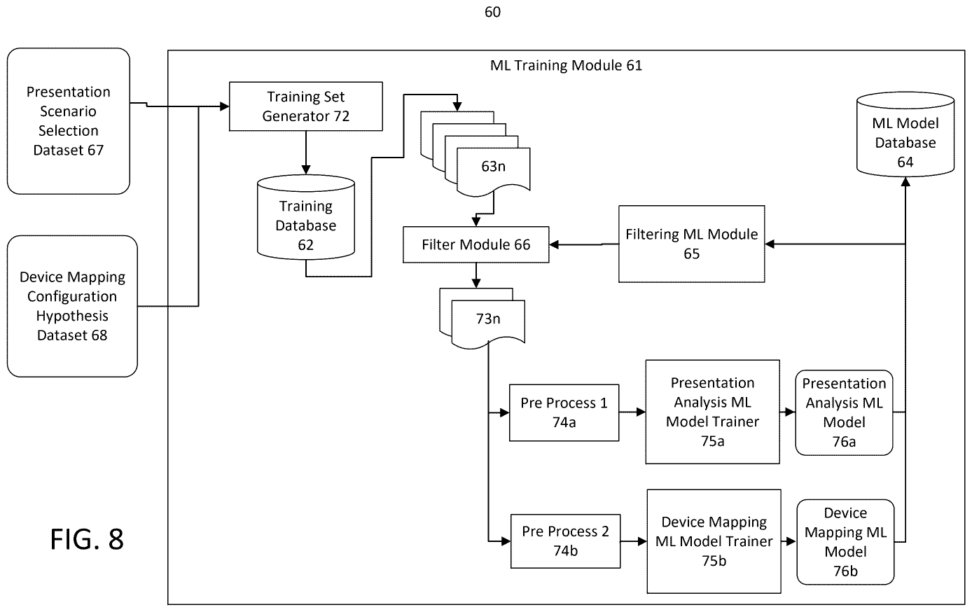

FIG. 8 is a block diagram illustrating a system 60 for preparing (which may include training, retraining, distillation, fine-tuning, etc.) one or more ML models for identifying a presentation scenario and one or more ML models for generating a device mapping configuration hypothesis, according to aspects of the present disclosure. As shown in system 60, an ML training module 61 is configured to build and prepare (which may include training, retraining, distillation, fine-tuning, etc.) specialized machine learning models with inference to perform particular tasks. This enables the specialized machine learning models to develop an ability to perform particular objectives on inputs that are not part of a training dataset. By subjecting the specialized machine learning models to large amounts of unlabeled and/or labeled trained data sets, the specialized machine learning models may perform particular tasks such as identifying a presentation scenario or generating a device mapping configuration hypothesis as described herein.

Supervised learning is effective for tasks such as classification (assigning inputs to predefined categories) and regression (predicting continuous values) since it relies on the availability of labeled data for both training and evaluation phases. In supervised learning, the ML training module 61 trains the model on a labeled dataset, where each input has a corresponding output. The goal is to learn a mapping function from inputs to outputs, allowing the model to make predictions or classifications on new, unseen data. The process typically involves the following steps: training, model building, prediction, feedback, and adjustment. In the training phase, the ML training module 61 provides the model with a training dataset including input-output pairs. The model learns the mapping function that relates inputs to outputs through an iterative process, adjusting its internal parameters based on the provided examples. During model building, a model is created that can generalize from the training data to make predictions on new, unseen data. The model's complexity varies based on the model type. For example, the model may be a simple linear regression model or a complex neural network. During the prediction phase, the ML training module 61 inputs test inputs (i.e., inputs with known outputs) into the model, which generates predictions or classifications based on what it has learned during training. The accuracy of predictions is evaluated by comparing them to the known outputs in a validation or test dataset. During the feedback and adjustment phase, the ML training module 61 refines the model based on feedback from its predictions. If the predictions differ from the actual outputs, the algorithm adjusts its internal parameters to minimize the errors. The performance of the trained model is assessed using metrics such as accuracy, precision, recall, etc., depending on the nature of the problem.

In some aspects, the ML training module 61 includes at least a training database 62 configured to store the raw training data 63n and corresponding labels, an ML model database 64 configured to store the trained models (e.g., presentation analysis ML model 76a and device mapping ML model 76b). In some aspects, the ML training module 61 may include a filtering machine learning module 65 and a filter module 66 configured to filter data from the training database 62 for training by removing poorly generated training data.

Training data from a presentation scenario selection dataset 67 and a device mapping configuration hypothesis dataset 68 is received into the ML training module 61 via the training set generator 72. In some aspects, the presentation scenario selection dataset 67 includes at least: a plurality of different presentation material (e.g., video, slides, documents, participant information, etc.), and a plurality of different presentation scenarios. In some aspects, the device mapping configuration hypothesis dataset 68 includes at least: a plurality of different presentation scenarios, a plurality of different device and system load information, and a plurality of different device mapping configuration hypothesis.

An optional filter module 66 is configured to filter out bad training images and/or data in order to clean up the training data in the training dataset 63n. In some examples, the filter module 66 may be a neural network. In some examples, the filter module 66 is a mathematical model. In some examples, the cleaned training dataset 73n then undergoes optional preprocessing steps depending on which neural network or model is being trained.

The optional preprocess 1 74a and preprocess 2 74b are automated processes that modify the raw data received from 63n (or cleaned training dataset 73n) and prepare the raw data as input to the respective model trainers (e.g., a presentation analysis ML model trainer 75a and a device mapping ML model trainer 75b). These may be described in the machine learning training module 61 as snippets of code that prepares the datasets. In some examples, the preprocessing module (e.g., preprocess 1 74a and preprocess 2 74b) for a particular trainer may be an automated script or code that will be setup the first time any model is trained.

The presentation analysis ML model trainer 75a and the device mapping ML model trainer 75b are the scripts or code that train the model. The presentation analysis ML model trainer 75a and the device mapping ML model trainer 75b may be a script or code that holds the instructions on how a model should be trained (e.g., optimization method, model architecture, dataset division, etc.) and also runs the training. The presentation analysis ML model trainer 75a and the device mapping ML model trainer 75b each take as input the raw or filtered processed training data and train the presentation analysis ML model 76a and the device mapping ML model 76b to achieve their specific objectives, respectively.

In summary, the raw dataset 63n or cleaned dataset 73n may optionally go through different preprocessing steps 74a and 74b and then a corresponding one of the presentation analysis ML model trainer 75a and the device mapping ML model trainer 75b to generate a trained presentation analysis ML model 76a and a trained device mapping ML model 76b. In some examples, each of these models may be a neural network.

As a non-limiting example, the machine learning may be a neural network. The neural network models are designed using a set of hyperparameters that define high-level aspects of their architecture and training process. These hyperparameters include, but are not limited to, a combination of architecture type, number of layers, memory size, number of attention heads, learning rate, batch size, optimization algorithm, and the like. Based on these hyperparameters, learnable variables called parameters are initialized, which define the mathematical function that the neural network represents.

The raw training dataset 63n used for preparing a model (which may include training, retraining, distillation, fine-tuning, etc.) may include noise and bad training data from the training database 62. Accordingly, to create a clean and filtered training dataset, the filter module 66 is configured to filter out unwanted data points from the raw training dataset 63n by developing smaller, less accurate systems based on patterns and metadata information.

During the preparing process (which may include training, retraining, distillation, fine-tuning, etc.), the presentation analysis ML model trainer 75a and the device mapping ML model trainer 75b (e.g., neural networks) are presented with input data and labels of actual values, and the optimization objective, which aims to minimize the difference between the actual value and the predicted value, is calculated. The optimization algorithm updates the parameters of the presentation analysis ML model trainer 75a and the device mapping ML model trainer 75b to reduce the value of the objective. This process is repeated for several iterations until the parameters do not change anymore. This process is repeated for various combinations of hyperparameters, and the model with the smallest label prediction error is selected as the final model.

When a new model (e.g., a trained presentation analysis ML model 76a or a trained device mapping ML model 76b) is created, and a new process for filtering and automated labeling is established, it is added to the ML model database 64 in the ML training module 61. This enables the new model to be part of the closed-loop model update process. Optionally, at regular intervals, data which is continuously collected can be filtered, labeled, and used to update old models by an optional filtering machine learning module 65. In some examples, the filtering machine learning module 65 is a neural network. In some examples, the filtering machine learning module 65 is a mathematical model. This approach may capture changes in the data over time.

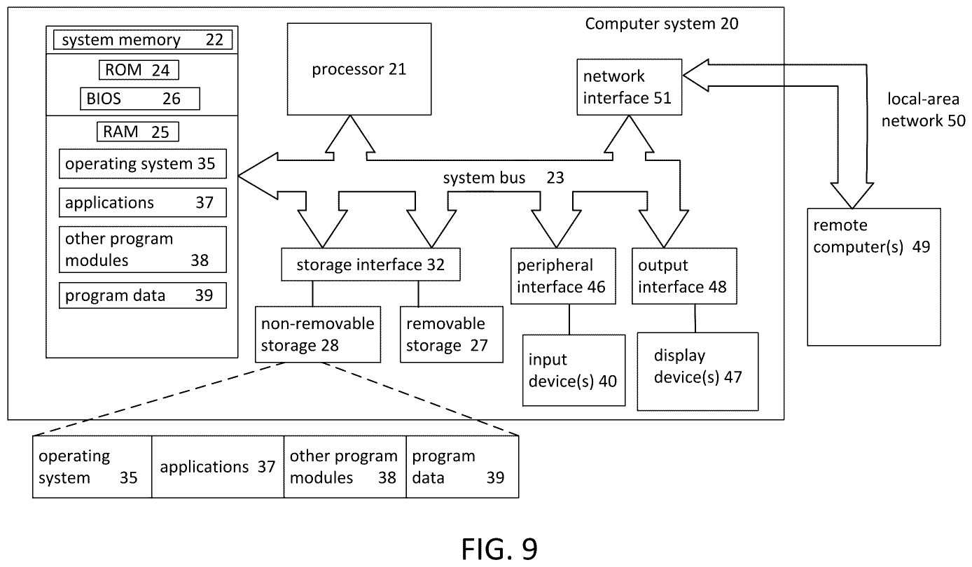

FIG. 9 is a block diagram illustrating a computer system 20 on which aspects of systems and methods for using machine learning to map available participant devices to various activities/functions of different presentation scenarios may be implemented in accordance with an exemplary aspect. The computer system 20 can be in the form of multiple computing devices, or in the form of a single computing device, for example, a desktop computer, a notebook computer, a laptop computer, a mobile computing device, a smart phone, a tablet computer, a server, a mainframe, an embedded device, and other forms of computing devices.

As shown, the computer system 20 includes a central processing unit (CPU) 21, a system memory 22, and a system bus 23 connecting the various system components, including the memory associated with the CPU 21. The system bus 23 may comprise a bus memory or bus memory controller, a peripheral bus, and a local bus that is able to interact with any other bus architecture. Examples of the buses may include PCI, ISA, PCI-Express, HyperTransport™, InfiniBand™, Serial ATA, I2C, and other suitable interconnects. The central processing unit 21 (also referred to as a processor) can include a single or multiple sets of processors having single or multiple cores. The processor 21 may execute one or more computer-executable code implementing the techniques of the present disclosure. For example, any commands/steps/functions discussed herein with reference to FIGS. 1-8 may be performed by processor 21. The system memory 22 may be any memory for storing data used herein and/or computer programs that are executable by the processor 21. The system memory 22 may include volatile memory such as a random access memory (RAM) 25 and non-volatile memory such as a read only memory (ROM) 24, flash memory, etc., or any combination thereof. The basic input/output system (BIOS) 26 may store the basic procedures for transfer of information between elements of the computer system 20, such as those at the time of loading the operating system with the use of the ROM 24.

The computer system 20 may include one or more storage devices such as one or more removable storage devices 27, one or more non-removable storage devices 28, or a combination thereof. The one or more removable storage devices 27 and non-removable storage devices 28 are connected to the system bus 23 via a storage interface 32. In an aspect, the storage devices and the corresponding computer-readable storage media are power-independent modules for the storage of computer instructions, data structures, program modules, and other data of the computer system 20. The system memory 22, removable storage devices 27, and non-removable storage devices 28 may use a variety of computer-readable storage media. Examples of computer-readable storage media include machine memory such as cache, SRAM, DRAM, zero capacitor RAM, twin transistor RAM, eDRAM, EDO RAM, DDR RAM, EEPROM, NRAM, RRAM, SONOS, PRAM; flash memory or other memory technology such as in solid state drives (SSDs) or flash drives; magnetic cassettes, magnetic tape, and magnetic disk storage such as in hard disk drives or floppy disks; optical storage such as in compact disks (CD-ROM) or digital versatile disks (DVDs); and any other medium which may be used to store the desired data and which can be accessed by the computer system 20.

The system memory 22, removable storage devices 27, and non-removable storage devices 28 of the computer system 20 may be used to store an operating system 35, additional program applications 37, other program modules 38, and program data 39. The computer system 20 may include a peripheral interface 46 for communicating data from input devices 40, such as a keyboard, mouse, stylus, game controller, voice input device, touch input device, or other peripheral devices, such as a printer or scanner via one or more I/O ports, such as a serial port, a parallel port, a universal serial bus (USB), or other peripheral interface. A display device 47 such as one or more monitors, projectors, or integrated display, may also be connected to the system bus 23 across an output interface 48, such as a video adapter. In addition to the display devices 47, the computer system 20 may be equipped with other peripheral output devices (not shown), such as loudspeakers and other audiovisual devices.

The computer system 20 may operate in a network environment, using a network connection to one or more remote computers 49. The remote computer (or computers) 49 may be local computer workstations or servers comprising most or all of the aforementioned elements in describing the nature of a computer system 20. Other devices may also be present in the computer network, such as, but not limited to, routers, network stations, peer devices or other network nodes. The computer system 20 may include one or more network interfaces 51 or network adapters for communicating with the remote computers 49 via one or more networks such as a local-area computer network (LAN) 50, a wide-area computer network (WAN), an intranet, and the Internet. Examples of the network interface 51 may include an Ethernet interface, a Frame Relay interface, SONET interface, and wireless interfaces.

Aspects of the present disclosure may be a system, a method, and/or a computer program product. The computer program product may include a computer readable storage medium (or media) having computer readable program instructions thereon for causing a processor to carry out aspects of the present disclosure.

The computer readable storage medium can be a tangible device that can retain and store program code in the form of instructions or data structures that can be accessed by a processor of a computing device, such as the computing system 20. The computer readable storage medium may be an electronic storage device, a magnetic storage device, an optical storage device, an electromagnetic storage device, a semiconductor storage device, or any suitable combination thereof. By way of example, such computer-readable storage medium can comprise a random access memory (RAM), a read-only memory (ROM), EEPROM, a portable compact disc read-only memory (CD-ROM), a digital versatile disk (DVD), flash memory, a hard disk, a portable computer diskette, a memory stick, a floppy disk, or even a mechanically encoded device such as punch-cards or raised structures in a groove having instructions recorded thereon. As used herein, a computer readable storage medium is not to be construed as being transitory signals per se, such as radio waves or other freely propagating electromagnetic waves, electromagnetic waves propagating through a waveguide or transmission media, or electrical signals transmitted through a wire.

Computer readable program instructions described herein can be downloaded to respective computing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network interface in each computing device receives computer readable program instructions from the network and forwards the computer readable program instructions for storage in a computer readable storage medium within the respective computing device.

Computer readable program instructions for carrying out operations of the present disclosure may be assembly instructions, instruction-set-architecture (ISA) instructions, machine instructions, machine dependent instructions, microcode, firmware instructions, state-setting data, or either source code or object code written in any combination of one or more programming languages, including an object oriented programming language, and conventional procedural programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a LAN or WAN, or the connection may be made to an external computer (for example, through the Internet). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present disclosure.

In various aspects, the systems and methods described in the present disclosure can be addressed in terms of modules. The term “module” as used herein refers to a real-world device, component, or arrangement of components implemented using hardware, such as by an application specific integrated circuit (ASIC) or FPGA, for example, or as a combination of hardware and software, such as by a microprocessor system and a set of instructions to implement the module's functionality, which (while being executed) transform the microprocessor system into a special-purpose device. A module may also be implemented as a combination of the two, with certain functions facilitated by hardware alone, and other functions facilitated by a combination of hardware and software. In certain implementations, at least a portion, and in some cases, all, of a module may be executed on the processor of a computer system. Accordingly, each module may be realized in a variety of suitable configurations, and should not be limited to any particular implementation exemplified herein.

In the interest of clarity, not all of the routine features of the aspects are disclosed herein. It would be appreciated that in the development of any actual implementation of the present disclosure, numerous implementation-specific decisions must be made in order to achieve the developer's specific goals, and these specific goals will vary for different implementations and different developers. It is understood that such a development effort might be complex and time-consuming, but would nevertheless be a routine undertaking of engineering for those of ordinary skill in the art, having the benefit of this disclosure.

Furthermore, it is to be understood that the phraseology or terminology used herein is for the purpose of description and not of restriction, such that the terminology or phraseology of the present specification is to be interpreted by the skilled in the art in light of the teachings and guidance presented herein, in combination with the knowledge of those skilled in the relevant art(s). Moreover, it is not intended for any term in the specification or claims to be ascribed an uncommon or special meaning unless explicitly set forth as such.

The various aspects disclosed herein encompass present and future known equivalents to the known modules referred to herein by way of illustration. Moreover, while aspects and applications have been shown and described, it would be apparent to those skilled in the art having the benefit of this disclosure that many more modifications than mentioned above are possible without departing from the inventive concepts disclosed herein.

1. A method of machine learning (ML)-assisted presentation hosting, comprising:
receiving, by a hosting platform, presentation materials associated with a presentation;
analyzing the presentation materials by a first ML model to predict a presentation scenario, which indicates a format of the presentation, a plurality of activities associated with the presentation, and one or more devices and/or software that perform the activities;
collecting information about a plurality of devices and/or software available to a plurality of participants of the presentation, wherein the collected information includes configuration, resources, capabilities, and/or load of the plurality of devices and/or software;
analyzing the presentation scenario and the collected information by a second ML model to predict a mapping of the plurality of activities to the plurality of devices and/or software of the plurality of participants, based on the configuration, resources, capabilities, and/or load of the plurality of devices and/or software, wherein the mapping indicates, at least, which devices and/or software of the plurality of participants are capable to perform which activities of the presentation; and
executing the presentation, by the hosting platform, including causing the plurality of devices and/or software of the participants to perform the mapped activities based on the mapping.

2. The method of claim 1, wherein the plurality of participants include a presenter of the presentation, the method further comprising, prior to executing the presentation:
providing the mapping on a user interface (UI) of a device associated with the presenter; and
modifying the mapping based on user input received via the UI from the presenter.

3. The method of claim 1, further comprising:
responsive to failure of at least one device and/or software in performing a mapped activity during the execution of the presentation, choosing, from the mapping, a different device and/or software to perform the failed activity of the presentation.

4. The method of claim 1, further comprising, prior to executing the presentation:
generating a presentation configuration hypothesis based on the mapping of the plurality of activities to the plurality of devices and/or software; and
testing the presentation configuration hypothesis by causing the plurality of devices and/or software to perform mapped ones of the plurality of activities, based on the mapping.

5. The method of claim 4, further comprising:
responsive to failure of at least one device and/or software to perform a mapped activity during the testing of the presentation configuration hypothesis, using the second ML model to create an alternative mapping of the plurality of activities to the plurality of devices and/or software of the plurality of participants.

6. The method of claim 1, wherein the configuration, resources, capabilities, and/or load of the plurality of devices and/or software comprises:
one or more input/output capture devices available in the plurality of devices and/or software;
a central processing unit (CPU) and/or memory load of the plurality of devices and/or software;
a relative physical location of the plurality of devices and/or software within the scenario and/or with respect to each other and/or with respect to a participant of the presentation;
a network speed/bandwidth of a communication medium used by the plurality of devices and/or software to communicate during the presentation;
availability and compatibility of required software on the plurality of devices and/or software; and/or
cybersecurity features of the plurality of devices and/or software.

7. The method of claim 1, wherein the first ML model comprises a large language model (LLM).

8. The method of claim 1, wherein the second ML model comprises one of a regression model, an encoder-decoder, and/or an autoencoder.

9. A system for machine learning (ML)-assisted presentation hosting, the system comprising:
at least one memory; and
at least one hardware processor coupled with the at least one memory and configured, individually or in combination, to:
receive presentation materials associated with a presentation;
analyze the presentation materials by a first ML model to predict a presentation scenario, which indicates a format of the presentation, a plurality of activities associated with the presentation, and one or more devices and/or software that perform the activities;
collect information about a plurality of devices and/or software available to a plurality of participants of the presentation, wherein the collected information includes configuration, resources, capabilities, and/or load of the plurality of devices and/or software;
analyze the presentation scenario and the collected information by a second ML model to predict a mapping of the plurality of activities to the plurality of devices and/or software of the participants, based on the configuration, resources, capabilities, and/or load of the plurality of devices and/or software, wherein the mapping indicates, at least, which devices and/or software of the participants is capable to perform which activities of the presentation; and
execute the presentation including causing the plurality of devices and/or software of the participants to perform the mapped activities based on the mapping.

10. The system of claim 9, wherein the plurality of participants include a presenter of the presentation, wherein the at least one hardware processor are configured, individually or in combination, to, prior to executing the presentation:
provide the mapping on a UI of a device associated with the presenter; and
modify the mapping based on user input received via the UI from the presenter.

11. The system of claim 9, wherein the at least one hardware processor is configured, individually or in combination, to responsive to failure of at least one device and/or software in performing a mapped activity during the execution of the presentation, choose, from the mapping, a different device and/or software to perform the failed activity of the presentation.

12. The system of claim 9, wherein the at least one hardware processor is configured, individually or in combination, to, prior to executing the presentation:
generate a presentation configuration hypothesis based on the mapping of the plurality of activities to the plurality of devices and/or software; and
test the presentation configuration hypothesis by causing the plurality of devices and/or software to perform mapped ones of the plurality of activities, based on the mapping.

13. The system of claim 12, wherein the at least one hardware processor is configured, individually or in combination, to responsive to failure of at least one device and/or software to perform a mapped activity during the testing of the presentation configuration hypothesis, use the second ML model to create an alternative mapping of the plurality of activities to the plurality of devices and/or software of the plurality of participants.

14. The system of claim 9, wherein the configuration, resources, capabilities, and/or load of the plurality of devices and/or software comprises:
one or more input/output capture devices available in the plurality of devices and/or software;
a central processing unit (CPU) and/or memory load of the plurality of devices and/or software;
a relative physical location of the plurality of devices and/or software within the scenario and/or with respect to each other and/or with respect to a participant of the presentation;
a network speed/bandwidth of a communication medium used by the plurality of devices and/or software to communicate during the presentation;
availability and compatibility of required software on the plurality of devices and/or software; and/or
cybersecurity features of the plurality of devices and/or software.

15. The system of claim 9, wherein the first ML model comprises a large language model (LLM).

16. The system of claim 9, wherein the second ML model comprises one of a regression model, an encoder-decoder, and/or an autoencoder.

17. A non-transitory computer readable medium storing thereon computer executable instructions for using machine learning (ML) to provide a presentation hosting platform, including instructions for:
receiving, by a hosting platform, presentation materials associated with a presentation;
analyzing the presentation materials by a first ML model to predict a presentation scenario, which indicates a format of the presentation, a plurality of activities associated with the presentation, and one or more devices and/or software that perform the activities;
collecting information about a plurality of devices and/or software available to a plurality of participants of the presentation, wherein the collected information includes configuration, resources, capabilities, and/or load of the plurality of devices and/or software;
analyzing the presentation scenario and the collected information by a second ML model to predict a mapping of the plurality of activities to the plurality of devices and/or software of the plurality of participants, based on the configuration, resources, capabilities, and/or load of the plurality of devices and/or software, wherein the mapping indicates, at least, which devices and/or software of the participants is capable to perform which activities of the presentation; and
executing the presentation, by the hosting platform, including causing the plurality of devices and/or software of the plurality of participants to perform the mapped activities based on the mapping.

18. The non-transitory computer readable medium of claim 17, further comprising instructions for, responsive to failure of at least one device and/or software in performing a mapped activity during the execution of the presentation, choosing, from the mapping, a different device and/or software to perform the failed activity of the presentation.

19. The non-transitory computer readable medium of claim 17, further comprising instructions for, prior to executing the presentation:
generating a presentation configuration hypothesis based on the mapping of the plurality of activities to the plurality of devices and/or software; and
testing the presentation configuration hypothesis by causing the plurality of devices and/or software to perform mapped ones of the plurality of activities, based on the mapping.

20. The non-transitory computer readable medium of claim 19, further comprising instructions for, responsive to failure of at least one device and/or software to perform a mapped activity during the testing of the presentation configuration hypothesis, using the second ML model to create an alternative mapping of the plurality of activities to the plurality of devices and/or software of the plurality of participants.
